(19) United States
(12) Patent Application Publication
(10) Pub. No.: US 2008/0284848 A1
(43) Pub. Date: Nov. 20, 2008

(54) Security surveillance planning tool kit

(76) Inventor: Peter Martin, Kahului, HI (US)

Correspondence Address: John R. Ross;Trex, 10455 Pacific Center CI, San Diego, CA, 92121, US

(21) Appl. No.: 11/511,909

(22) Filed: Aug. 28, 2006

Related U.S. Application Data
(60) Provisional application No. 60/711,515, filed on Aug. 26, 2005.

(51) Int. Cl. H04N 7/18

(52) U.S. Cl. 348/143; 348/E07.085

(57) ABSTRACT

A surveillance planning and analysis tool kit for planning and analysis at a region. The tool kit includes a computer system programmed with software adapted to simulate optical and imaging parameters at the region including a realistic geo-spatial map of the region, a number of surveillance cameras, camera specifications and lighting conditions. Preferred embodiments include computer software to permit planning and analysis of optical imaging technologies in the 400 nm-1700 nm spectrum that comprises the visible, near infrared, and short wave infrared where the primary signal is ambient light reflected from objects.

The present invention relates to planning systems and in particular to such systems for surveillance planning. The present invention claims the benefit of Provisional Patent Application 60/711,515 filed Aug. 26, 2006.

### BACKGROUND OF THE INVENTION

### Surveillance Systems

Surveillance systems are in wide use in the United States and elsewhere. Many industrial and commercial installations include such systems especially to monitor for thefts. Sabotage is also a growing concern because to the threat of terrorism. Local, state and federal governments are engaged to some extent in surveillance to help protect against this terrorism threat. Military installations are a potential target of terrorist activity and surveillance at such military installation is an important consideration. Providing a good surveillance program at an installation can be extremely expensive. And it is very important that planners understand how well the program will function once it is complete.

### Satellite Tool Kit

The Satellite Tool Kit is a very successful computer software toolkit for satellite planning and analysis. It is owned by Analytical Graphics, Inc. Analytical Graphics makes the basic program available free but charges for add-on services. It is used by more than 30,000 professionals worldwide to support all phases of satellite planning and analysis. The software calculates data and displays multiple 2-D maps to permit visualization of time dependent information for satellites and other space related objects.

### The PMRF

The Pacific Missile Range Facility is the world's largest instrumented multi-environment range capable of supporting surface, subsurface, air, and space operations simultaneously. There are over 1100 square miles of instrumented underwater range and over 42,000 square miles of controlled airspace. This makes PMRF a premier facility for supporting operations which vary from small, single-unit exercises up to large scale, multiple-unit battle group scenarios.

What is needed is a Tool Kit similar to the Satellite Tool Kit that can be used for surveillance planning and analysis.

### SUMMARY OF THE INVENTION

The present invention provides a surveillance planning and analysis tool kit for planning and analysis at a region. The tool kit includes a computer system programmed with software adapted to simulate optical and imaging parameters at the region including a realistic geo-spatial map of the region, a number of surveillance cameras, camera specifications and lighting conditions. Preferred embodiments include computer software to permit planning and analysis of optical imaging technologies in the 400 nm-1700 nm spectrum that comprises the visible, near infrared, and short wave infrared where the primary signal is ambient light reflected from objects. Additional surveillance capabilities can be added to the basic program. A preferred embodiment is implemented in Microsoft Windows and will feature Wizard packages to enable the user to set up surveillance scenarios. This preferred embodiment enables a user to create a system of multiple optical surveillance cameras located at arbitrary positions on a realistic geo-spatial map of specific regions, which may be a military base or a large industrial site. The system enables input of camera specifications including pixel format, pixel count, focal length, f-number, spectral quantum efficiency, sensor noise budget, dynamic range, optical resolution (i.e. point spread function), integration time, and cost. It also enables input of the position and pointing vector of the optical axis of the camera. For example, the program operators can position cameras and display the angular field of view on a simulated map.

### BRIEF DESCRIPTION OF THE DRAWINGS

FIG. 1 is reproduction of a map produced by the prior art Satellite Tool Kit.

FIG. 2 is a map of the Pacific Missile Range Facility.

FIG. 3 is an enhanced view of the above facility.

FIG. 4 is a diagram showing a surveillance camera.

FIG. 5 shows the variation of solar wavelengths.

FIG. 6 shows night time irradiation verses wavelength.

### DETAILED DESCRIPTION OF PREFERRED EMBODIMENTS

### Surveillance Planning Tool Kit for PMRF

A first preferred embodiment of the present invention is a surveillance planning tool kit for the Pacific Missile Range Facility (PMFR). This facility is described briefly in the background section o this specification. The tool kit would enable detailed planning and assessment for the PMRF security surveillance. The tool kit uses, as a starting analogy, the Satellite Tool Kit software that is available from Analytical Graphics, Inc. That software is well accepted in the intelligence community for detailed analysis of reconnaissance and communication satellites in orbital configurations around the earth. A typical graphical user interface for the Windows-based program is displayed in FIG. 1. Users can create multiple satellites in arbitrary orbits and equipped with multiple sensor capabilities, as well as multiple ground-based objects (facilities, vehicles, targets, and sensors), overlaid on a realistic geo-spatial map of the earth using Windows-based Wizard packages. The user can perform a number of analysis functions, accessed by toolbars, including visibility, altitude, and sensor analysis. The program output includes visualization tools and comprehensive data reporting that can be ported to standard programs such as Microsoft Word, Excel, and Powerpoint.

Applicant's software program will provide the tools and analysis necessary for detailed modeling of the PMRF security surveillance system. The tool kit will address optical imaging technologies in the 400 nm-1700 nm spectrum that comprises the visible, near infrared, and short wave infrared where the primary signal is ambient light reflected from objects. Additional surveillance capabilities can be added to the basic program as discussed at the end of this section. The program will be implemented in Microsoft Windows and will feature Wizard packages to enable the user to set up surveillance scenarios. Examples of the graphical interface are displayed in FIGS. 2 and 3. The program will enable viewing of the entire PMRF, as displayed in FIG. 2, or viewing of detailed subsections of the PMRF, as displayed in FIG. 3.

A Camera Wizard will enable a user to create a system of multiple optical surveillance cameras located at arbitrary positions on a realistic geo-spatial map of the PMRF. The Camera Wizard will enable input of camera specifications including pixel format, pixel count, focal length, f-number, spectral quantum efficiency, sensor noise budget, dynamic range, optical resolution (i.e. point spread function), integration time, and cost. The Wizard will also enable input of the position and pointing vector of the optical axis of the camera. The tool kit will position the camera and display the angular field of view on the simulated PMRF user interface map. The tool kit will calculate the “object spatial resolution” at all positions within the angular field of view of the optical camera. The optical special resolution (OSR) is defined as

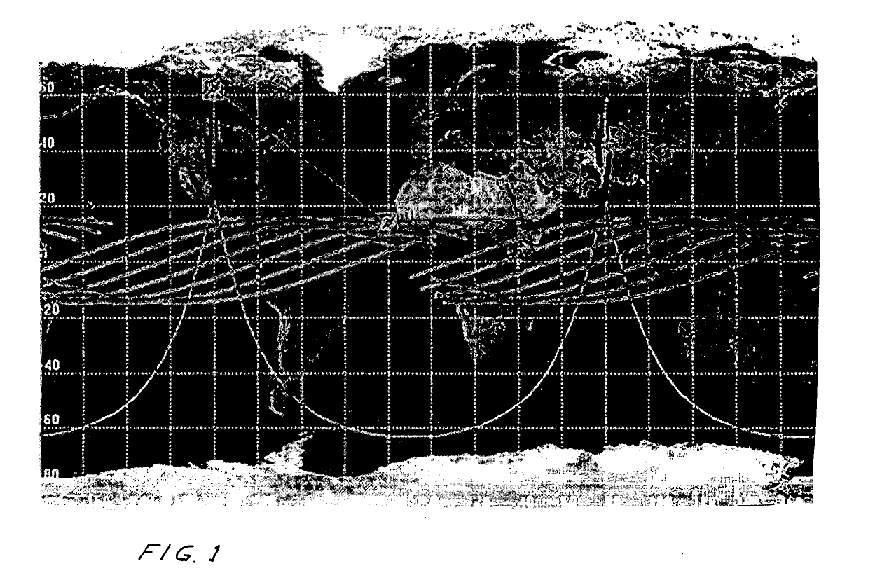

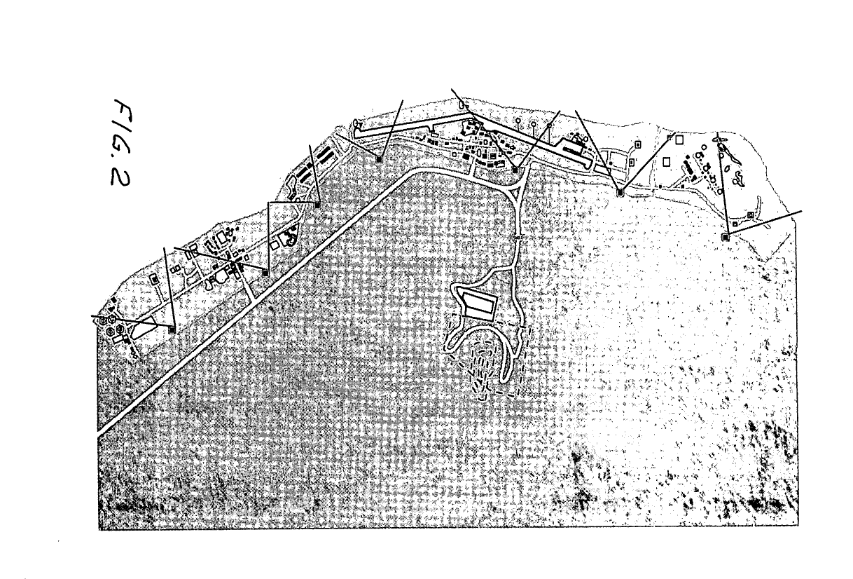

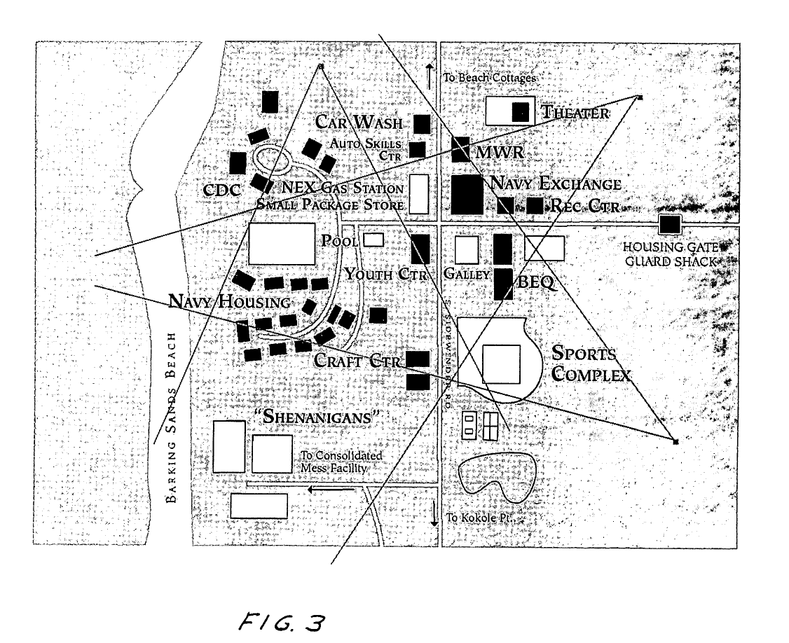

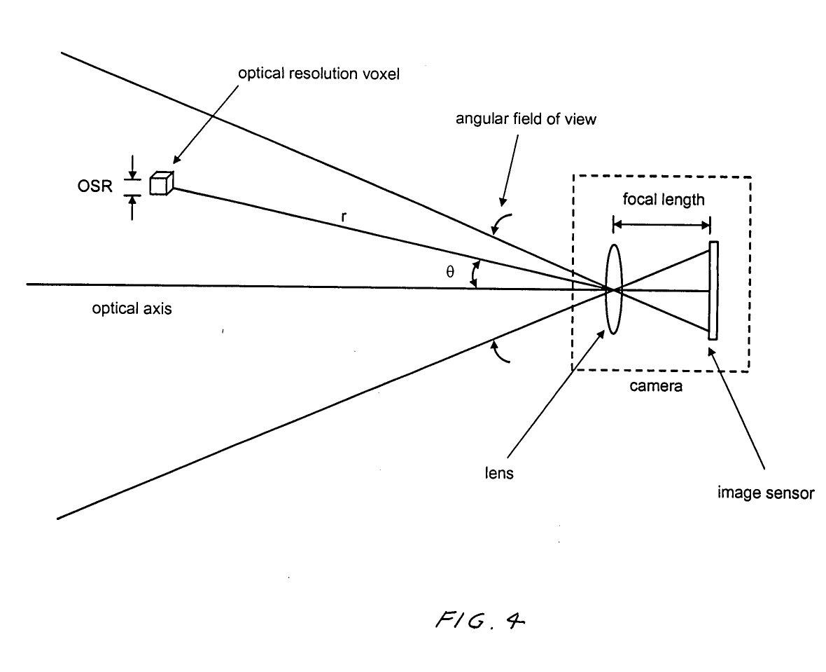

OSR=r*PSF(θ) Eq. (1)

where r is the distance from a viewing camera position to the object, θ is the angle between the object and the optical axis, and PSF(θ) is the angular full width half maximum (FWHM) of point spread function (i.e. blur spot) of the camera. The tool kit will calculate a symmetric three dimensional “optical resolution voxel” as a cube with sides equal to OSR, as displayed in FIG. 4. The PSF(θ) has a minimum value on the optical axis PSF(θ)=PSF(θ=0), and broadens off the optical axis due to higher order lens aberrations (coma, spherical aberration, chromatic aberration, etc).

The tool kit's basic program will calculate a map of the optical spatial resolution OSR at each spatial position on the PMRF by choosing the minimum OSR from the within the angular fields of view of all cameras “looking” at the particular position.

An Illumination Wizard will enable the user to create a global illumination of the PMRF, from sunlight, moonlight, and starlight illumination. The user will select from the categories similar to those displayed in Table 1. The program will then provide the spectral illumination profile for each situation from look up tables in units of Watts/cm²-μm versus wavelength and calculate convolutions of the spectral irradiance data with the spectral quantum efficiency curves of a particular image sensor.

TABLE 1
Ambient lighting for various natural lighting conditions.

| Condition | Ambient lighting (lux) |
|---|---|
| Stare at direct sun | 100,000 |
| Full daylight | 10,000 |
| Overcast sky | 1,000 |
| Very dark sky | 100 |
| Evening sky | 100 |
| Good Street Lighting | 20 |
| Twilight | 10 |
| Deep Twilight | 1 |
| Full moon | 0.1 |
| Starlight | 0.0001 |

The spectral irradiance versus wavelength curves are different for each of the situations in Table 1. In full daylight, the spectrum is peaked in the blue due to the λ⁻⁴ dependence of Rayleigh scattering of sunlight (wavelength λ); in addition, the Rayleigh scattering causes the illumination to be omnidirectional. In the evening, the spectrum shifts towards the red because Rayleigh scattering selectively filters out the blue light. The National Renewable Energy Laboratory (NREL) has developed analytical models of solar irradiance for all environmental conditions including location on earth, time of day, and weather conditions. FIG. 5 displays the spectrum for the “stare at direct sun” situation. The models (i.e. mathematical equations) and experimental measurements, developed for precise calculations of electrical power outputs of solar power facilities, are available on-line.

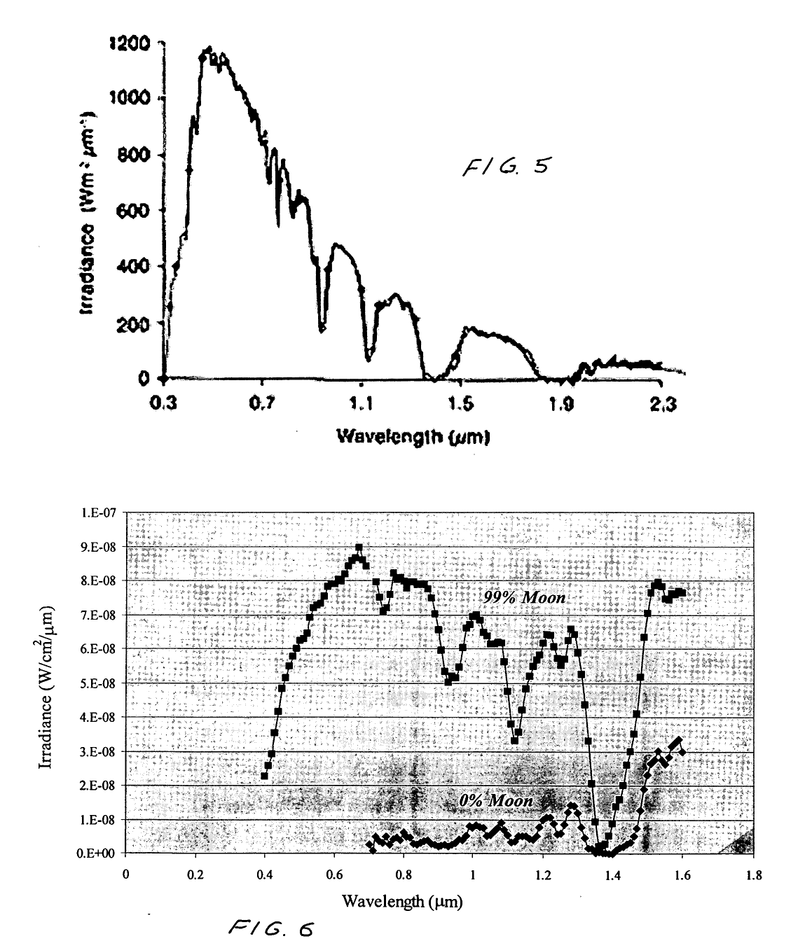

The Illumination Wizard will provide spectral irradiance data for moonlight and starlight conditions, displayed in FIG. 6, which was recently measured by the Night Vision Laboratories. The majority of the integrated spectrum for these conditions is shifted to the near infrared and short wave infrared (1-2 microns).

The Illumination Wizard will also enable the user to position streetlamps at arbitrary positions on the simulated PMRF map. The tool kit program will calculate the streetlamp illumination using lamp irradiance data (high and low pressure sodium spectra, for example) with an R⁻² falloff in intensity where R is the distance from the streetlamp to a position on the PMRF map.

The program will calculate the light intensity Iₛₑₙₛₒᵣ incident on the sensor of a particular camera using

$${I}_{sensor} = \frac{( {I}_{o} ) ( R ) ( T )}{4 {( f \# )}^{2}} \qquad Eq . ( 2 )$$

where Iₒ is the ambient illumination convolved with the quantum efficiency of the sensor, R is the object reflectance, T is the transmission of the camera lens, f# is the f-number of the camera. The program will also calculate the shot noise associated with Iₛₑₙₛₒᵣ, as well as the signal-to-noise ratio of a particular camera as a ratio of (Tᵢₙₜ)(Iₛₑₙₛₒᵣ) to the total noise the camera sensor.

The tool kit program will be primarily designed to assist in the evaluation of available and emerging digital image sensors. This program will calculate the “sensor spatial resolution” (SSR) of the simulated digital camera as

SSR=f*PSF(θ) Eq. (3)

where f is the focal length of the camera and PSF(θ) is the angular full width half maximum of the point spread function (i.e. blur spot) of the camera. Digital sampling theory specifies that the optimal sampling frequency for a digital image sensor in a camera is two pixels per SSR; this is the minimal spatial frequency required to prevent digital sampling aliasing. The program will set the default sampling frequency of the camera as two pixels per SSR on the optical axis. This will provide a certain amount of “over-sampling” off the optical axis due to the broadening of the PSF(θ) off the optical axis. The program will also provide a user selectable value for the sampling frequency for digital cameras that “over-sample” on the optical axis.

The basic program will calculate the minimum resolvable contrast (MRC) of objects of arbitrary feature size at arbitrary positions on the simulated PMRF map. MRC models are well developed for imaging applications¹ and depend on the camera resolution (i.e. function of the range, or distance between camera and object) and signal-to-noise characteristics, as well as the ambient illumination. (See R. Littleton, K. Dang, P. Maloney, and P. Perconti, “Spectral Irradiance of the Night Sky for Passive Low Light Level Imaging Applications” 2005). The program will also perform range predictions based on Johnson criteria that relate camera performance to discrimination levels such as detection, orientation, recognition, and identification.

### Refinements

The basic tool kit program will provide a framework for future refinements and developments some of which are described below:
1) Experimental Validation and Refinement: The basic tool kit is based on measurable physical parameters; these parameters can be measured by the test bed system and either verified or refined based upon the experimental results as well as refinements to the program metrics. Refinement examples include: transition from scalar to vector metrics such as direction dependent illumination and image obscuration and shadowing due to building and objects.
2) Passive Thermal and Microwave Imaging: The program can be expanded to position mid-wave infrared and long-wave infrared cameras (3-20 micron wavelengths), as well a passive microwave cameras (70-120 GHz) on the simulated PMRF map. Minimum resolvable contrast analysis of thermal sources with arbitrary feature size, temperature, emissivity, and position can be calculated.
3) Other Sensor Technologies: The program can be expanded to feature audio sensors (directional and omni-directional microphones) and audio sources. The direct modeling analogies of passive audio versus thermal imaging analysis includes decibel versus thermal emission, microphone antenna patterns versus point spread function calculations, minimum audio detectability versus minimum resolvable contrast, and audio Johnson criteria (i.e. detection of audio sources, identification of audio sources, eavesdropping, etc.) In addition, modeling of active sensing systems, such as radar and acoustic (ultrasound) imaging systems can be added to the program.
4) Facial Analysis Toolkit: The facial recognition development community is well established as evidenced by the 2005 “Facial Recognition Grand Challenge” sponsored by the National Institute of Standards and Technology (NIST), the National Institute of Justice (NIJ) and other agencies. Facial recognition algorithms can be combined with the output of the basic SST program to provide analysis of facial recognition efficacy at various positions on the PMRF.
5) Behavioral Analysis Toolkit: The behavioral aspects of humans under surveillance are a major thrust for PMRF test bed development effort. These developments can potentially be added to the basic SST program for analysis purposes.
6) Expand Simulated PMRF Map: The simulated PMRF map can be expanded to include land outside of the PMRF, the ocean adjoining the PMRF, and the airspace above the PMRF.
7) Extend SST program to arbitrary location: The entire program scenario can be transferred to provide security analysis at any locale on the earth.

While the present invention has been described in terms of a specific embodiment; i.e. a tool kit for the PMRF, persons skilled in the art will recognize that the principals of the present invention can be applied in a very large number of other situations. For example, any of the many hundred of military installations all over the earth; important national landmarks that could be subject of terrorist attack, commercial nuclear installations, other industrial facilities, large parks and recreation facilities including theme parks such as Disneyland. The region that is the subject of the tool kit could include regions such as large cities or crime regions within a city. Therefore, the scope of the invention should be determined by the appended claims and not the specific embodiments described above.

What is claimed is:

1. A surveillance planning and analysis tool kit for planning and analysis at a region, said tool kit comprising a computer system programmed with software adapted to simulate optical and imaging parameters at the region wherein said parameters are programmable and include:
A) a realistic geo-spatial map of the region,
B) a plurality of surveillance cameras,
C) camera specifications, and
D) lighting conditions.

2. The tool kit as in claim 1 wherein said lighting conditions include the 400 nm-1700 nm spectrum that comprises the visible, near infrared, and short wave infrared where the primary signal is ambient light reflected from objects.

3. The tool kit as in claim 1 wherein said camera specifications include pixel format, pixel count, focal length, f-number, spectral quantum efficiency, sensor noise budget, dynamic range, optical resolution (i.e. point spread function), integration time, and cost.

4. The tool kit as in claim 1 wherein said tool kit is implemented in Microsoft Windows and will feature Wizard packages to enable the user to set up surveillance scenarios.

5. The tool kit as in claim 1 wherein the region is a military base.

6. The tool kit as in claim 1 wherein the region comprises a military base.

7. The tool kit as in claim 1 wherein the region comprises a nuclear plant.

8. The tool kit as in claim 1 wherein the region comprises an industrial plant.

9. The tool kit as in claim 1 wherein the region comprises a theme park.

10. The tool kit as in claim 1 wherein the region is a city or a portion of a city.
